(19) United States
(12) Patent Application Publication
(10) Pub. No.: US 2025/0286964 A1
(43) Pub. Date: Sep. 11, 2025

(54) INFORMATION PROCESSING SYSTEM, INFORMATION PROCESSING METHOD, AND NON-TRANSITORY RECORDING MEDIUM

(71) Applicant: Aoi NAKAMURA, Tokyo (JP)

(72) Inventor: Aoi NAKAMURA, Tokyo (JP)

(21) Appl. No.: 19/059,296

(22) Filed: Feb. 21, 2025

(30) Foreign Application Priority Data
Mar. 5, 2024 (JP) 2024-033299

(51) Int. Cl. H04N 1/00; G06K 7/14

(52) U.S. Cl. CPC H04N 1/00344; H04N 1/00244; H04N 1/00334; G06K 7/1417; H04N 2201/0094

(57) ABSTRACT

An information processing system includes an information processing apparatus operated by an operator, a function execution apparatus to execute a function, and a management apparatus to communicate with the information processing apparatus and the function execution apparatus. The management apparatus includes first circuitry to generate a code corresponding to a setting to be used in executing the function and transmit the code. The information processing apparatus includes second circuitry to receive the code and display, on a display, the code. The function execution apparatus includes third circuitry to read the code displayed on the display and execute the function based on the setting corresponding to the code read by the third circuitry.

### CROSS-REFERENCE TO RELATED APPLICATIONS

This patent application is based on and claims priority pursuant to 35 U.S.C. § 119 (a) to Japanese Patent Application No. 2024-033299, filed on Mar. 5, 2024, in the Japan Patent Office, the entire disclosure of which is hereby incorporated by reference herein.

### BACKGROUND

### Technical Field

The present disclosure relates to an information processing system, an information processing method, and a non-transitory recording medium.

### Related Art

As known in the art, a cloud print service is used. In the cloud print service, print data is uploaded from, for example, a smartphone to a destination such as a server, and an image forming apparatus such as a multifunction peripheral downloads the print data from the destination and executes printing based on the print data.

For example, a technique for enabling the cloud print service is disclosed. According to the technique, an operator operates a smartphone to display, on the screen of the smartphone, a QUICK RESPONSE (QR) CODE representing print information including information on a destination and information on print setting. A multifunction peripheral reads and analyzes the QR CODE, decodes the print information encoded in the QR CODE, which includes the information on the destination from which print data is to be acquired and the information on the print setting, and sets the number of sheets to be printed and a sheet size according to the information on the print setting.

### SUMMARY

In one aspect, an information processing system includes an information processing apparatus operated by an operator, a function execution apparatus to execute a function, and a management apparatus to communicate with the information processing apparatus and the function execution apparatus. The management apparatus includes first circuitry to generate a code corresponding to a setting to be used in executing the function and transmit the code.

The information processing apparatus includes second circuitry to receive the code and display, on a display, the code. The function execution apparatus includes third circuitry to read the code displayed on the display and execute the function based on the setting corresponding to the code read by the third circuitry.

In another aspect, an information processing system includes an information processing apparatus operated by an operator, a function execution apparatus to execute a function, and a management apparatus to communicate with the information processing apparatus and the function execution apparatus. The management apparatus includes first circuitry to transmit a value corresponding to a setting to be used in executing the function. The information processing apparatus includes second circuitry to receive the value, generate a code corresponding to the setting using the value, and display, on a display, the code. The function execution apparatus includes third circuitry to read the code displayed on the display and execute the function based on the setting corresponding to the code read by the third circuitry.

In another aspect, an information processing method performed by an information processing system including an information processing apparatus operated by an operator, a function execution apparatus, and a management apparatus, includes, with the management apparatus, generating a code corresponding to a setting to be used in executing a function of the function execution apparatus, transmitting the code from the management apparatus to the information processing apparatus, displaying the code on a display for the information processing apparatus, reading the displayed code with the function execution apparatus, and executing, with the function execution apparatus, the function based on the setting corresponding to the code that is read.

In another aspect, a non-transitory recording medium stores a plurality of program codes which, when executed by one or more processors on an information processing system including an information processing apparatus operated by an operator, a function execution apparatus, and a management apparatus, causes the one or more processors to perform an information processing method including, with the management apparatus, generating a code corresponding to a setting to be used in executing a function of the function execution apparatus, transmitting the code from the management apparatus to the information processing apparatus, displaying the code on a display for the information processing apparatus, reading the displayed code with the function execution apparatus, and executing, with the function execution apparatus, the function based on the setting corresponding to the code that is read.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an information processing system according to a first embodiment;

FIG. 2 is a block diagram illustrating a hardware configuration of a management apparatus;

FIG. 3 is a block diagram illustrating a hardware configuration of an information processing apparatus;

FIG. 4 is a block diagram illustrating a hardware configuration of a function execution apparatus;

FIG. 5 is a block diagram illustrating a functional configuration of each apparatus included in an information processing system according to the first embodiment;

FIG. 6 is a diagram illustrating a table indicating the correspondence between settings and identifications (IDs);

FIG. 7 is a flowchart of a process to execute a function according to the first embodiment;

FIG. 8 is a block diagram illustrating a functional configuration of each apparatus included in an information processing system according to a second embodiment;

FIG. 9 is a sequence diagram illustrating a process to execute a function according to the second embodiment;

FIG. 10 is a block diagram illustrating a functional configuration of each apparatus included in an information processing system according to a third embodiment;

FIG. 11 is a sequence diagram illustrating a process to execute a function according to the third embodiment;

FIG. 12 is a block diagram illustrating a functional configuration of each apparatus included in an information processing system according to a fourth embodiment;

FIG. 13 is a diagram illustrating a version list, and sets of information on all settings for each version and IDs corresponding to the respective settings;

FIG. 14 is a sequence diagram illustrating a process to execute a function according to the fourth embodiment;

FIG. 15 is a block diagram illustrating a functional configuration of each apparatus included in an information processing system according to a fifth embodiment; and

FIG. 16 is a sequence diagram illustrating a process to execute a function according to the fifth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system, an information processing method, and a non-transitory recording medium according to embodiments of the present disclosure are described in detail below with reference to the accompanying drawings.

### First Embodiment

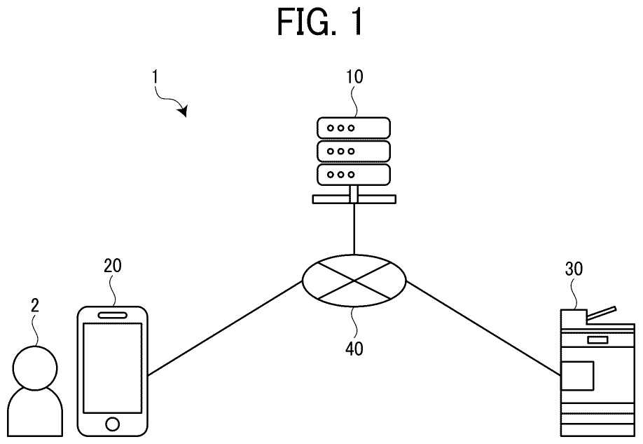

FIG. 1 is a diagram illustrating a configuration of an information processing system 1 according to a first embodiment. The information processing system 1 according to the present embodiment includes an information processing apparatus 20, a function execution apparatus 30, and a management apparatus 10, which are connected to one another via a communication network 40 such as the Internet. The information processing apparatus is used by an operator 2. The function execution apparatus 30 is an example of a multifunction peripheral/printer (MFP) or a facsimile machine. Each apparatus is described in detail below.

The information processing apparatus 20 is a communication terminal used by the operator 2 to instruct the function execution apparatus 30 to execute a function such as printing or scanning. The information processing apparatus 20 is, for example, a smartphone or a tablet terminal. The function execution apparatus 30 executes a function instructed by the operator 2. Examples of the function are printing, scanning, copying, and facsimile communication. The management apparatus 10 is a computer connected to a cloud service via the communication network 40. The management apparatus 10 is an information processing apparatus such as a server, a desktop personal computer (PC), or a laptop personal computer (PC). The management apparatus 10 exchanges information with the information processing apparatus 20 and the function execution apparatus 30, and provides services for the function execution apparatus 30 to execute the function.

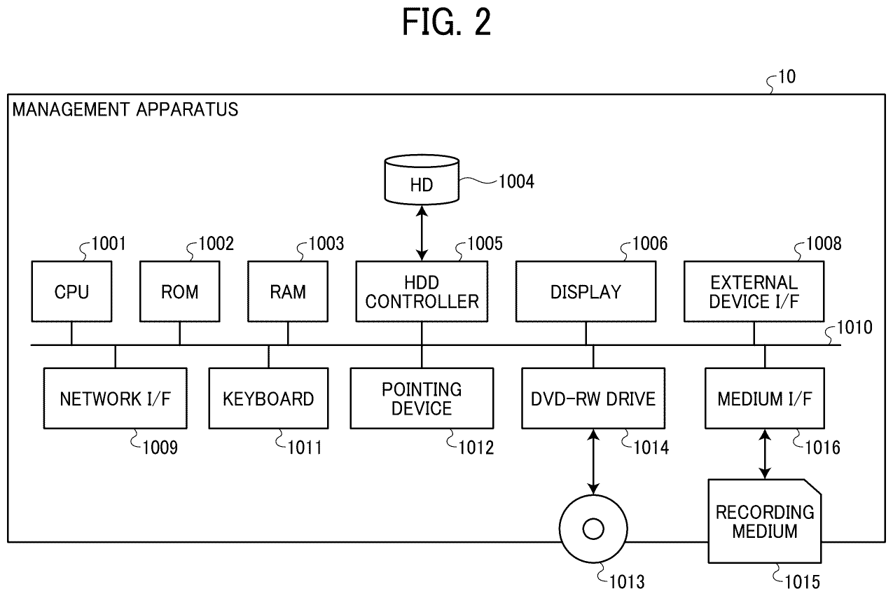

FIG. 2 is a block diagram illustrating a hardware configuration of the management apparatus 10 implemented by a server, a desktop PC, or a laptop PC.

As illustrated in FIG. 2, the management apparatus 10 is implemented by a computer. The computer includes a central processing unit (CPU) 1001, a read-only memory (ROM) 1002, a random-access memory (RAM) 1003, a hard disk (HD) 1004, a hard disk drive (HDD) controller 1005, a display 1006, an external device interface (I/F) 1008, a network interface (I/F) 1009, a bus line 1010, a keyboard 1011, a pointing device 1012, a digital versatile disc-rewritable (DVD-RW) drive 1014, and a medium interface (I/F) 1016.

The CPU 1001 controls the entire operation of the management apparatus 10. The ROM 1002 stores a program such as an initial program loader (IPL) used for booting the CPU 1001. The RAM 1003 is used as a work area for the CPU 1001. The HD 1004 is a storage unit that stores various data such as a program. The HDD controller 1005 controls the reading and writing of data from and to the HD 1004 under the control of the CPU 1001. The display 1006 is a display device including a liquid crystal panel or an organic electro-luminescence (EL) panel that displays various types of information such as a cursor, a menu, a window, characters, and an image.

The external device I/F 1008, which may be implemented by an interface circuit, is an interface for connection with various external devices. The network I/F 1009, which may be implemented by an interface circuit, is an interface that controls the communication of data through the communication network 40. The bus line 1010 is, for example, an address bus or a data bus, which electrically connects the components or elements such as the CPU 1001 illustrated in FIG. 2.

The keyboard 1011 serves as an input device provided with a plurality of keys used for, for example, inputting characters, numerical values, and various instructions. The pointing device 1012 serves as an input device used for, for example, selecting or executing various instructions, selecting an object to be processed, and moving a cursor being displayed. As the pointing device 1012, a mouse, a touch pad, a trackball, a joystick, or a pen tablet may be used. The display 1006 and the pointing device 1012 may be implemented by a touch panel display having respective functions.

The DVD-RW drive 1014 controls the reading and writing of various data from and to a DVD-RW 1013, which serves as a removable recording medium according to the present embodiment. The removable recording medium is not limited to a DVD-RW and may be, for example, a digital versatile disc-recordable (DVD-R). The medium I/F 1016, which may be implemented by an interface circuit, controls the reading and writing (storing) of data from and to a recording medium 1015 such as a flash memory. The DVD-RW 1013 and the recording medium 1015 are examples of a storage unit for the management apparatus 10.

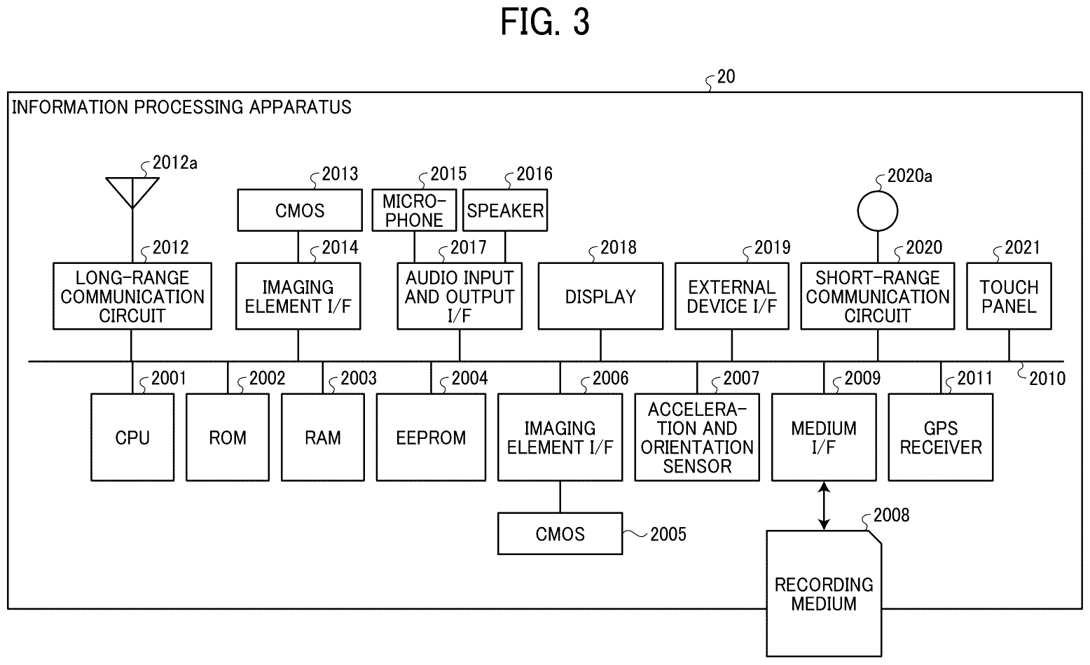

FIG. 3 is a block diagram illustrating a hardware configuration of the information processing apparatus 20 implemented by a smartphone or a tablet terminal. As illustrated in FIG. 3, the information processing apparatus 20 includes a CPU 2001, a ROM 2002, a RAM 2003, an electrically erasable programmable read-only memory (EEPROM) 2004, a complementary metal oxide semiconductor (CMOS) sensor 2005, an imaging element interface (I/F) 2006, an acceleration and orientation sensor 2007, a medium I/F 2009, and a global positioning system (GPS) receiver 2011.

The CPU 2001 controls the entire operation of the information processing apparatus 20. The ROM 2002 is a storage unit that stores, for example, a program used by the CPU 2001 and a program such as an IPL used for booting the CPU 2001. The RAM 2003 is used as a work area for the CPU 2001. The EEPROM 2004 is a storage unit that reads and writes various data such as a program for a smartphone under the control of the CPU 2001. The CMOS sensor 2005 is a kind of built-in imaging device that captures an image of an object (typically, a self-image of the operator 2) under the control of the CPU 2001 to obtain image data. In alternative to the CMOS sensor, an imaging device such as a charge-coupled device (CCD) sensor may be used. The imaging element I/F 2006 is a circuit that controls the driving of the CMOS sensor 2005. The acceleration and orientation sensor 2007 serves as various sensors such as an electromagnetic compass or gyrocompass for detecting geomagnetism and an acceleration sensor. The medium I/F 2009, which may be implemented by an interface circuit, controls the reading and writing (storing) of data from and to a recording medium 2008 such as a flash memory. The recording medium 2008 is an example of a storage unit for the information processing apparatus 20. The GPS receiver 2011 receives a GPS signal from a GPS satellite.

The information processing apparatus 20 further includes a long-range communication circuit 2012, an antenna 2012a for the long-range communication circuit 2012, a CMOS sensor 2013, an imaging element I/F 2014, a microphone 2015, a speaker 2016, an audio input and output interface (I/F) 2017, a display 2018, an external device I/F 2019, a short-range communication circuit 2020, an antenna 2020a for the short-range communication circuit 2020, and a touch panel 2021.

The long-range communication circuit 2012 is a circuit for communicating with other devices via the communication network 40. The CMOS sensor 2013 is a kind of built-in imaging device that captures an image of an object under the control of the CPU 2001 to obtain image data. The imaging element I/F 2014 is a circuit that controls the driving of the CMOS sensor 2013.

The microphone 2015 is a built-in circuit that converts audio into electrical signals. The speaker 2016 is a built-in circuit that converts electrical signals into physical vibrations to produce audio such as music or voice. The audio input and output I/F 2017 is a circuit that processes the input and output of audio signals between the microphone 2015 and the speaker 2016 under the control of the CPU 2001. The display 2018 serves as a display that displays an image of an object and various icons, such as a liquid crystal display or an organic electro-luminescence (EL) display. The external device I/F 2019, which may be implemented by an interface circuit, is an interface for connection with various external devices. The short-range communication circuit 2020 is a communication circuit in compliance with, for example, the near field communication (NFC) or BLUETOOTH. The touch panel 2021 is a kind of a pointing device. The touch panel 2021 serves as an input device that allows the operator 2 to operate the information processing apparatus 20 by touching, for example, a button displayed on the display 2018.

The information processing apparatus 20 further includes a bus line 2010. The bus line 2010 is, for example, an address bus or a data bus, which electrically connects the components or elements such as the CPU 2001 illustrated in FIG. 3.

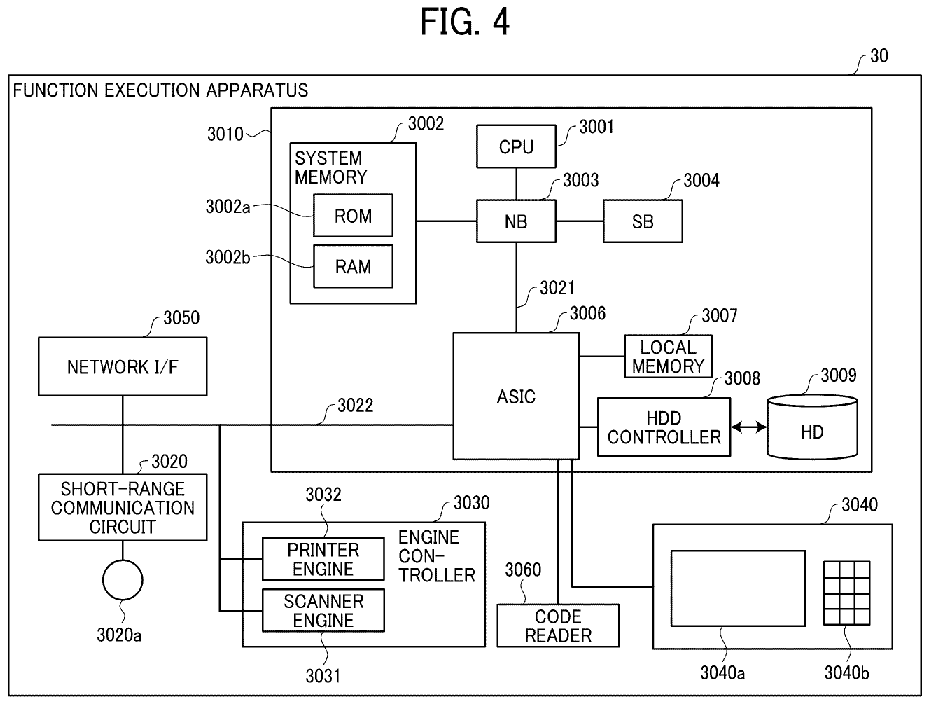

FIG. 4 is a block diagram illustrating a hardware configuration of the function execution apparatus 30 implemented by an MFP. As illustrated in FIG. 4, the function execution apparatus 30 includes a controller 3010, a short-range communication circuit 3020, an engine controller 3030, an operation panel 3040, a network I/F 3050, and a code reader 3060.

The controller 3010 includes a CPU 3001 as a main processor of the computer, a system memory 3002, a north bridge (NB) 3003, a south bridge (SB) 3004, an application-specific integrated circuit (ASIC) 3006, a local memory 3007 as a storage unit, an HDD controller 3008, and an HD 3009 as a storage unit. The NB 3003 and the ASIC 3006 are connected to each other through an accelerated graphics port (AGP) bus 3021.

The CPU 3001 controls the entire operation of the function execution apparatus 30. The NB 3003 is a bridge that connects the CPU 3001 to the system memory 3002, the SB 3004, and the AGP bus 3021. The NB 3003 includes a memory controller to control the reading from and writing to the system memory 3002, a peripheral component interconnect (PCI) master, and an AGP target.

The system memory 3002 includes a ROM 3002a and a RAM 3002b. The ROM 3002a stores programs and data for implementing various functions of the controller 3010. The RAM 3002b is used as a memory to load the programs and the data. The RAM 3002b is used as, for example, a drawing memory to store drawing data for printing. For the distribution, the programs stored in the ROM 3002a may be stored in any computer-readable recording medium, such as a compact disc-read only memory (CD-ROM), a compact disc-recordable (CD-R), or a digital versatile disc (DVD), in a file format installable or executable by a computer.

The SB 3004 is a bridge for connecting the NB 3003 to PCI devices and peripheral devices. The ASIC 3006 is an integrated circuit (IC) dedicated to image processing and includes hardware elements for image processing. The ASIC 3006 serves as a bridge to connect the AGP bus 3021, a PCI bus 3022, the HDD controller 3008, and the local memory 3007 to one another. The ASIC 3006 includes a PCI target, an AGP master, an arbiter (ARB) as a central processor of the ASIC 3006, a memory controller to control the local memory 3007, a plurality of direct memory access controllers (DMACs), and a PCI unit. For example, the DMACs convert coordinates of image data with hardware logic to rotate an image based on the image data. The PCI unit transfers data between a scanner engine 3031 and a printer engine 3032 through the PCI bus 3022. The ASIC 3006 may be connected to a universal serial bus (USB) interface, or an Institute of Electrical and Electronics Engineers (IEEE) 1394 interface.

The local memory 3007 is a memory used as a buffer for image data to be copied or a code buffer. The HD 3009 is a storage device (storage unit) that stores image data, font data for printing, and form data. The HDD controller 3008 controls the reading and writing of data from and to the HD 3009 under the control of the CPU 3001. The AGP bus 3021 is a bus interface for a graphics accelerator card, which has been proposed to accelerate graphics processing. The AGP bus 3021 directly accesses the system memory 3002 with high throughput to accelerate the graphics accelerator card.

The short-range communication circuit 3020 includes an antenna 3020a for the short-range communication circuit 3020. The short-range communication circuit 3020 is a communication circuit in compliance with, for example, the NFC or BLUETOOTH.

The engine controller 3030 includes the scanner engine 3031 and the printer engine 3032. The operation panel 3040 includes a display panel 3040a and a control panel 3040b. The display panel 3040a is, for example, a touch panel that displays current settings or a selection screen and receives input from the operator 2. The control panel 3040b includes, for example, a numeric keypad and a start key. The numeric keypad receives assigned values of image reading or forming parameters such as an image density parameter. The start key receives an instruction to start copying, for example. The controller 3010 controls the entire operation of the function execution apparatus 30. For example, the controller 3010 controls drawing, communication, and input through the operation panel 3040. The scanner engine 3031 or the printer engine 3032 includes an image processor to perform, for example, error diffusion and gamma conversion.

In response to an instruction to select a specific application through the operation panel 3040 by use of, for example, an application (or mode) switch key, the function execution apparatus 30 selectively performs a document server function, a copying function, a printing function, and a facsimile communication function. When the document server function is selected, an operation mode switches to a document box mode. With selection of the copying function, the operation mode switches to a copy mode. With selection of the printing function, the operation mode switches to a printer mode. With selection of the facsimile communication function, the operation mode switches to a facsimile mode.

The network I/F 3050, which may be implemented by an interface circuit, is an interface that controls the communication of data through the communication network 40. The short-range communication circuit 3020 and the network I/F 3050 are electrically connected to the ASIC 3006 via the PCI bus 3022.

The code reader 3060 is a code reading device that reads a code displayed on the display of the information processing apparatus 20 as described below. In the case where the code is an image representing characters such as numerals, the code reader includes a camera and recognizes the numerals captured by the camera using a technique of image recognition.

In the case where the code is a bar code or a QUICK RESPONSE (QR) CODE, the code reader serves as a bar code reader or a QR code reader, and outputs information embedded in the code read by the code reader. For example, the code reader may be connected to the main body of the function execution apparatus 30 through a cable, or may be provided for the operation panel 3040.

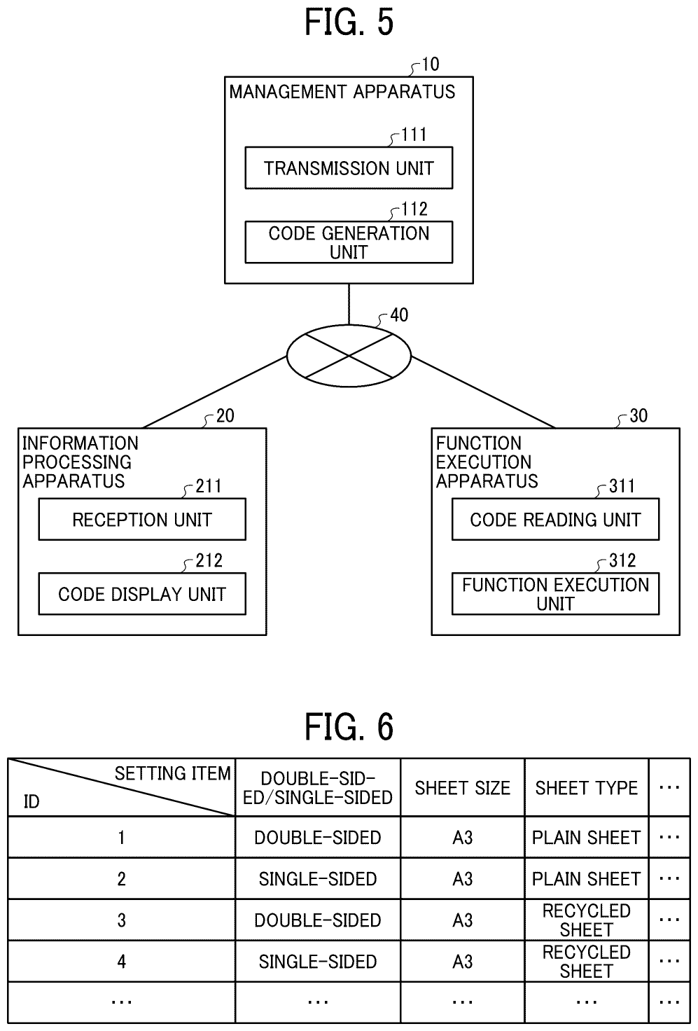

FIG. 5 is a block diagram illustrating a functional configuration of each apparatus included in the information processing system 1 according to the first embodiment.

The management apparatus 10 includes a transmission unit 111 and a code generation unit 112. These functional units are implemented by cooperation of the hardware and software (e.g., a program) included in the management apparatus 10 as illustrated in FIG. 2. Alternatively, at least one of the functional units may be implemented by dedicated hardware (e.g., a circuit). The functional units of the management apparatus 10 are not limited thereto.

The information processing apparatus 20 includes a reception unit 211 and a code display unit 212. These functional units are implemented by cooperation of the hardware and software (e.g., a program) included in the information processing apparatus 20 as illustrated in FIG. 3. Alternatively, at least one of the functional units may be implemented by dedicated hardware (e.g., a circuit). The functional units of the information processing apparatus 20 are not limited thereto.

The function execution apparatus 30 includes a code reading unit 311 and a function execution unit 312. These functional units are implemented by cooperation of the hardware and software (e.g., a program) included in the function execution apparatus 30 as illustrated in FIG. 4. Alternatively, at least one of the functional units may be implemented by dedicated hardware (e.g., a circuit). The functional units of the function execution apparatus 30 are not limited thereto.

The transmission unit 111 transmits a code corresponding to a setting registered by the operator 2 to the information processing apparatus 20. In the present embodiment, the setting is used for executing a function such as printing or scanning. Examples of the setting include a setting of color printing or monochrome printing, a setting of single-sided printing or double-sided printing, a setting of a sheet size, and a setting of resolution in scanning. It is assumed that the operator 2 registers a setting of a function in the information processing apparatus 20 using an input device such as the touch panel 2021 and the information processing apparatus 20 transmits the information on the setting to the management apparatus 10.

The code generation unit 112 generates a code corresponding to the setting registered by the operator 2. In the present embodiment, the code is information that allows all settings (all combinations of setting values) that can be set for a function to be executed to be identified. The code may be an identification (ID) (e.g., a value) such as a numerical value corresponding to each setting, or may be a one-dimensional code such as a bar code or a two-dimensional code such as a QR CODE. In the case where the code is a one-dimensional code or a two-dimensional code, a code may be generated in which an ID corresponding to the setting is embedded.

FIG. 6 is a diagram illustrating a table indicating the correspondence between settings and IDs. In the table, the IDs are indicated in the leftmost column, and the settings (a specific setting value of each setting item) corresponding to the respective IDs are indicated in the columns to the right of the IDs. The management apparatus 10 stores information on all settings (setting information) and IDs corresponding to the respective settings as sets in a storage unit such as the HD 1004.

The reception unit 211 receives the code transmitted from the transmission unit 111. The code display unit 212 displays the code received by the reception unit 211 on a display such as the display 2018. The code display unit 212 displays a numerical value when the code is a numerical value such as an ID, and displays an image of a two-dimensional code when the code is a QR CODE.

The code reading unit 311 reads the code displayed by the code display unit 212. The code reading unit 311 reads the numerical value in the code using a technique of image recognition or character recognition when the code is a numerical value, and reads the code using a bar code reader or a QR code reader when the code is a bar code or a QR CODE.

The function execution unit 312 executes a function such as printing or scanning based on a setting corresponding to the code read by the code reading unit 311. The function execution apparatus 30 stores the information on all settings (setting information) and the IDs corresponding to the respective settings as sets in a storage unit such as the HD 3009. In the case where the code is a numerical value such as an ID, the function execution unit 312 searches the table illustrated in FIG. 6 to acquire a setting corresponding to the ID, and executes a function based on the setting. In the case where the code is a QR CODE, the code reading unit 311 acquires an ID embedded in the QR CODE, and the function execution unit 312 acquires a setting corresponding to the ID using the ID received from the code reading unit 311 and the table.

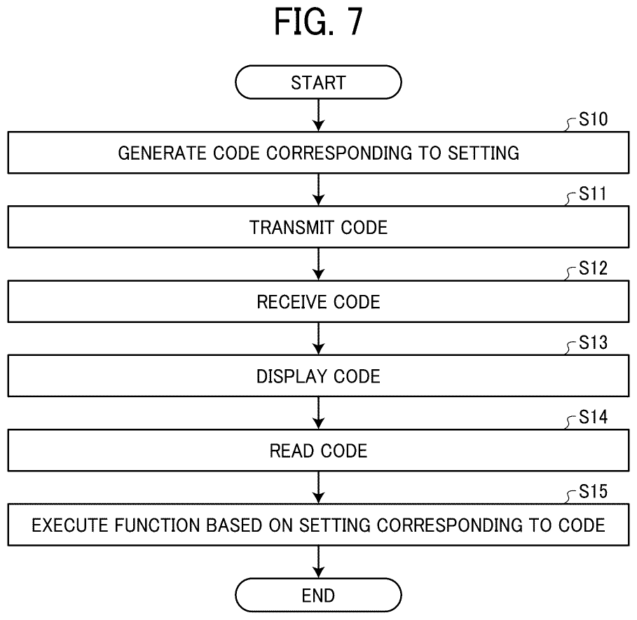

FIG. 7 is a flowchart of a process to execute a function according to the first embodiment. First, in step S10, the code generation unit 112 generates a code corresponding to a setting to be registered by the operator 2. The operator 2 operates an input device such as the touch panel 2021 of the information processing apparatus 20 to select a setting to be registered, and presses a registration button displayed on the display 2018 to register the setting. The information on the registered setting is transmitted from the information processing apparatus 20 to the management apparatus 10 via the communication network 40.

In step S11, the transmission unit 111 transmits a code corresponding to the setting registered by the operator 2 to the information processing apparatus 20. In step S12, the reception unit 211 receives the code transmitted from the transmission unit 111. In step S13, the code display unit 212 displays the code received by the reception unit 211 on a display such as the display 2018.

In step S14, the operator 2 holds the code displayed on the code display unit 212 over the code reading unit 311, and the code reading unit 311 reads the displayed code. In step S15, the function execution unit 312 executes a function based on the setting corresponding to the read code.

According to the technique in the art, since the amount of data of the information on the print setting is large, there are some issues that it takes time to download the information on the print setting in a network of slow speed, and that the storage capacity of the server is significantly affected when the information on the print setting is stored for operators individually. In addition, since the target of the cloud printing service is limited to the printing function, there is another issue that the cloud printing service cannot be used for services to executes a variety of functions including functions other than the printing function.

As described above, according to the present embodiment, the setting information is transmitted to the function execution apparatus 30 by holding the code displayed by the information processing apparatus 20 over the function execution apparatus 30 that can execute various functions. Accordingly, even when the amount of data in the setting information is large, the setting information registered by the operator 2 is smoothly transmitted to the function execution apparatus 30. In addition, the management apparatus 10 generates a code corresponding to the setting. Thus, the information processing apparatus 20 does not need to generate the code, and the amount of processing executed by the information processing apparatus 20 is reduced. Furthermore, the management apparatus 10 and the function execution apparatus 30 store, in the respective storage units, the information on the settings having a finite number of combinations of setting values and the IDs corresponding to the respective settings. Thus, the amount of data to be stored is reduced, compared to, for example, a case where the information on the settings is stored for an unspecified number of operators individually.

In the present embodiment, the management apparatus 10 includes the code generation unit. Alternatively, the information processing apparatus 20 may include the code generation unit, and the information processing apparatus 20 executes the processing to generate a code based on the setting registered by the operator 2. In this case, the ID (value) corresponding to the setting registered by the operator 2 may be transmitted from the transmission unit 111 to the reception unit 211, and the information processing apparatus 20 may generate a code (a code in which the ID is embedded) corresponding to the received ID. Thus, the data transmitted from the management apparatus 10 to the information processing apparatus 20 is data such as an ID whose amount of information is small, and the amount of data related to the setting information transmitted from the management apparatus 10 to the information processing apparatus 20 is reduced.

### Second Embodiment

A second embodiment is described below. In the present embodiment, how data such as setting information and an ID is exchanged between the apparatuses to execute a function is described in more detail.

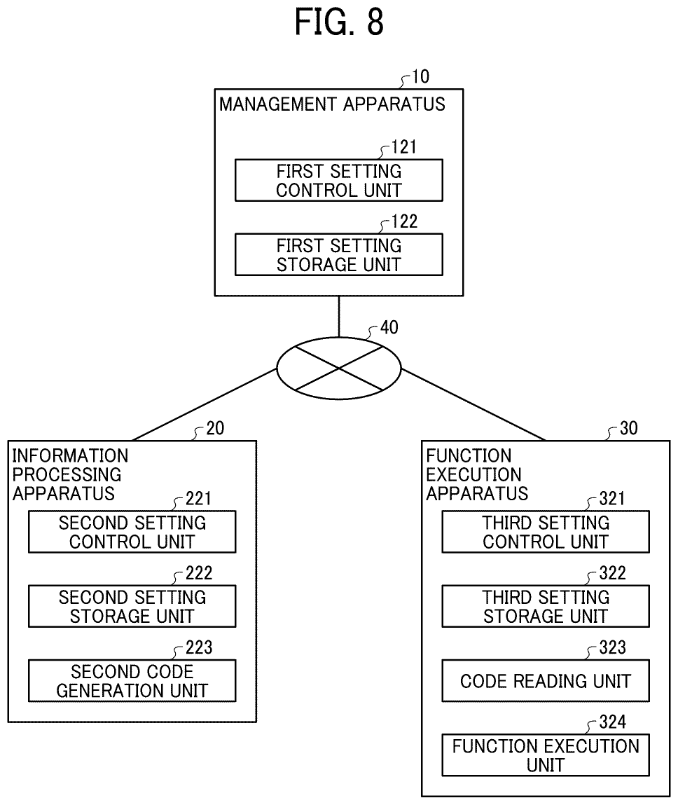

FIG. 8 is a block diagram illustrating a functional configuration of each apparatus included in the information processing system 1 according to the second embodiment. The management apparatus 10 includes a first setting control unit 121 and a first setting storage unit 122. These functional units are implemented by cooperation of the hardware and software (e.g., a program) included in the management apparatus 10 as illustrated in FIG. 2. Alternatively, at least one of the functional units may be implemented by dedicated hardware (e.g., a circuit). The functional units of the management apparatus 10 are not limited thereto.

The information processing apparatus 20 includes a second setting control unit 221, a second setting storage unit 222, and a second code generation unit 223. These functional units are implemented by cooperation of the hardware and software (e.g., a program) included in the information processing apparatus 20 as illustrated in FIG. 3. Alternatively, at least one of the functional units may be implemented by dedicated hardware (e.g., a circuit). The functional units of the information processing apparatus 20 are not limited thereto.

The function execution apparatus 30 includes a third setting control unit 321, a third setting storage unit 322, a code reading unit 323, and a function execution unit 324. These functional units are implemented by cooperation of the hardware and software (e.g., a program) included in the function execution apparatus 30 as illustrated in FIG. 4. Alternatively, at least one of the functional units may be implemented by dedicated hardware (e.g., a circuit). The functional units of the function execution apparatus 30 are not limited thereto.

As described above, the management apparatus 10 stores the information on all settings and the IDs corresponding to the respective settings as sets in a storage unit such as the HD 1004.

The first setting control unit 121 reads the information on all settings and the IDs from the first setting storage unit 122, and transmits the read data to the function execution apparatus 30. In addition, the first setting control unit 121 inquires of the first setting storage unit 122 for the ID (value) corresponding to a specific setting information (information on the setting registered by the operator 2) received from the information processing apparatus 20, and transmits the ID (value) returned from the first setting storage unit 122 to the information processing apparatus 20. As described above, the first setting control unit 121 has a transmission function that is a function to transmit a value corresponding to the setting.

The first setting storage unit 122 reads the information on all settings and the IDs from the storage unit and transmits the read data to the first setting control unit 121. The first setting storage unit 122 returns an ID corresponding to the specific setting transmitted from the first setting control unit 121 to the first setting control unit 121. In the present embodiment, the first setting storage unit 122 is an example of a storage unit that reads or writes setting information and an ID.

The information on the setting registered by the operator 2 and the code corresponding to the setting are stored in the storage unit such as the EEPROM 2004 of the information processing apparatus 20. Multiple sets of setting information and codes may be stored in the storage unit.

The second setting control unit 221 transmits the information on the setting registered by the operator 2 to the management apparatus 10, and receives an ID (a value) corresponding to the setting from the first setting control unit 121. As described above, the second setting control unit 221 has a reception function that is a function to receive a value corresponding to the setting.

The second setting control unit 221 requests the second code generation unit 223 to generate a code corresponding to the received ID, instructs the second setting storage unit 222 to store the information on the setting registered by the operator 2 and the code as a set, and displays the setting registered by the operator 2 and the code on a display such as the display 2018. As described above, the second setting control unit 221 has a function similar to the function of the code display unit 212 described in the first embodiment.

The second setting storage unit 222 stores the information on the setting registered by the operator 2 and the code as a set in the storage unit. The second code generation unit 223 generates a code corresponding to the ID. In the present embodiment, the second setting storage unit 222 is an example of a storage unit that reads or writes setting information and an ID.

The information on all settings and the IDs corresponding to the respective settings transmitted from the management apparatus 10 are stored as sets in a storage unit such as the HD 3009 of the function execution apparatus 30. For this purpose, the third setting control unit 321 requests the first setting control unit 121 to transmit the information on all settings and the IDs. The third setting control unit 321 requests the third setting storage unit 322 to transmit the setting information corresponding to the ID transmitted from the code reading unit 323, and returns the setting information corresponding to the ID received from the third setting storage unit 322 to the function execution unit 324 in response to the request for the setting information from the function execution unit 324.

The third setting storage unit 322 reads the setting information corresponding to the ID received from the third setting control unit 321 from the storage unit and returns the setting information to the third setting control unit 321. The code reading unit 323 transmits an ID corresponding to the read code to the third setting control unit 321. In the present embodiment, the third setting storage unit 322 is an example of a storage unit that reads or writes setting information and an ID.

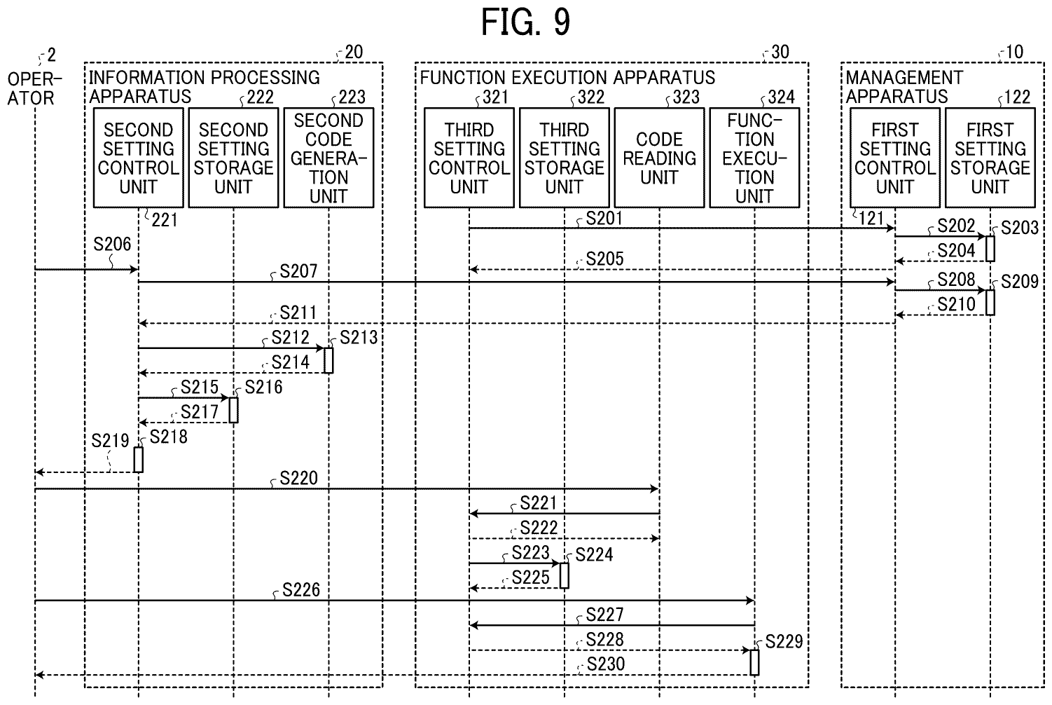

FIG. 9 is a sequence diagram illustrating a process to execute a function according to the second embodiment. In the present embodiment, a solid arrow indicates, for example, a request for processing or operation, an instruction, or data registration. In the case where a solid arrow indicates a request or instruction, a dotted arrow indicates a response corresponding to the request or instruction.

First, in step S201, the third setting control unit 321 requests the first setting control unit 121 to transmit the information on all settings and the IDs. In step S202, the first setting control unit 121 requests the first setting storage unit 122 to read out the information on all settings and the IDs. In step S203, the first setting storage unit 122 reads the information on all settings and the IDs from the storage unit. In steps S204 and S205, the first setting control unit 121 transmits the information on all settings and the IDs received from the first setting storage unit 122 to the third setting control unit 321. The operations described above are executed in advance before the operator 2 uses the function execution apparatus 30. For example, at a timing when the operator 2 is not using the function execution apparatus 30, the function execution apparatus 30 requests the management apparatus 10 for the setting information.

In step S206, the operator 2 registers a favorite setting or a frequently used setting using the information processing apparatus 20. For example, the operator 2 operates an input device such as the touch panel 2021 of the information processing apparatus 20 to select a setting to be registered, and presses a registration button displayed on the display 2018 to register the setting. In step S207, the second setting control unit 221 transmits the information on the setting registered in the information processing apparatus 20 to the first setting control unit 121.

In step S208, the first setting control unit 121 requests the first setting storage unit 122 to transmit an ID corresponding to the received setting information. In step S209, the first setting storage unit 122 searches the storage unit for the requested ID. In step S210, the first setting storage unit 122 transmits the searched ID to the first setting control unit 121. In step S211, the first setting control unit 121 transmits the received ID to the second setting control unit 221.

In step S212, the second setting control unit 221 requests the second code generation unit 223 to generate a code corresponding to the received ID. In step S213, the second code generation unit 223 generates a code corresponding to the ID transmitted from the second setting control unit 221. In step S214, the second code generation unit 223 returns the generated code to the second setting control unit 221. In step S215, the second setting control unit 221 requests the second setting storage unit 222 to store the setting information and the code corresponding to the setting information. In step S216, the second setting storage unit 222 stores the setting information and the code corresponding to the setting information. In step S217, the second setting storage unit 222 notifies the second setting control unit 221 of the completion of the storage. In steps S218 and S219, the second setting control unit 221 displays the setting information and the code corresponding to the setting information on the display.

In step S220, the operator 2 holds the code displayed on the display of the information processing apparatus 20 over the code reading unit 323 to cause the code reading unit 323 to read the code.

In step S221, the code reading unit 323 transmits an ID corresponding to the read code to the third setting control unit 321. In step S222, the third setting control unit 321 causes the code reading unit 323 to end the reading operation. In step S223, the third setting control unit 321 requests the third setting storage unit 322 to transmit setting information corresponding to the received ID. In step S224, the third setting storage unit 322 searches the storage unit for the setting information corresponding to the ID. In step S225, the third setting storage unit 322 transmits the searched setting information to the third setting control unit 321.

In step S226, the operator 2 presses an execution button displayed on, for example, the display 2018 of the function execution apparatus 30. In step S227, the function execution unit 324 inquires of the third setting control unit 321 for the setting information. In step S228, the third setting control unit 321 transmits the setting information received from the third setting storage unit 322 in step S225 to the function execution unit 324. In steps S229 and S230, the function execution unit 324 executes a function using a setting corresponding to the received setting information. The sequence when the operator 2 registers one setting is described above. By repeating the operations in steps S206 to S219, the operator 2 is allowed to register multiple settings.

As described above, according to the present embodiment, by using the ID corresponding to the information on the setting registered by the operator 2, the amount of data of the setting information transmitted from the management apparatus 10 to the information processing apparatus 20 is reduced. In addition, the setting information is transmitted to the function execution apparatus 30 by holding the code generated by the information processing apparatus 20 over the function execution apparatus 30 that can execute various functions. Accordingly, even when the amount of data in the setting information is large, the setting information registered by the operator 2 is smoothly transmitted to the function execution apparatus 30. Furthermore, the management apparatus 10 and the function execution apparatus 30 store, in the respective storage units, the information on the settings having a finite number of combinations of setting values and the IDs corresponding to the respective settings. Thus, the amount of data to be stored is reduced, compared to, for example, a case where the information on the settings is stored for an unspecified number of operators individually.

### Third Embodiment

A third embodiment is described below. In the present embodiment, instead of the information processing apparatus 20, the management apparatus 10 has the function to generate a code.

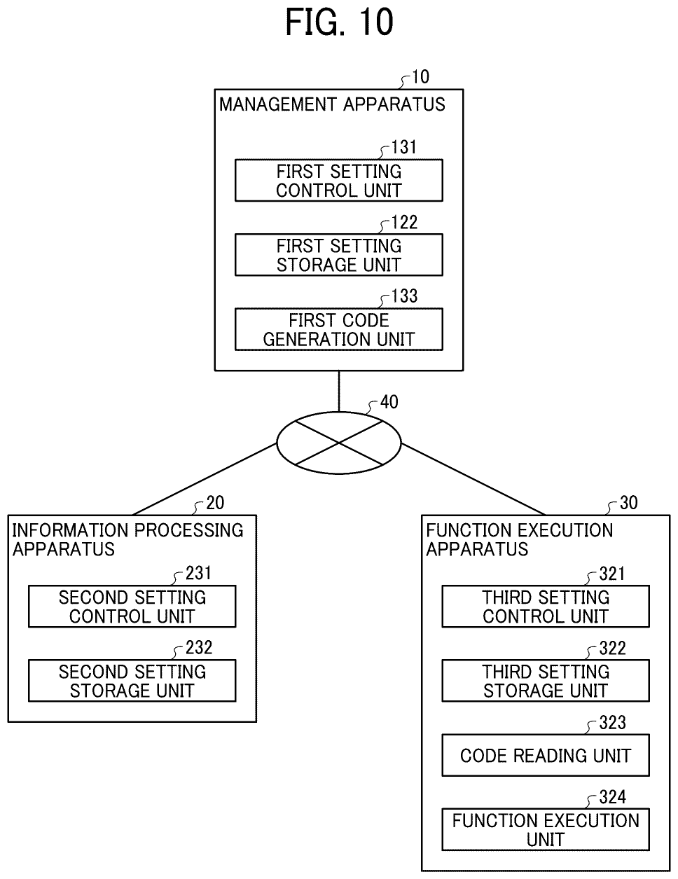

FIG. 10 is a block diagram illustrating a functional configuration of each apparatus included in the information processing system 1 according to the third embodiment. The difference from the second embodiment is that the management apparatus 10 includes a first code generation unit 133 instead of the information processing apparatus 20 including the second code generation unit 223. Accordingly, a code corresponding to the setting information can be generated by the management apparatus 10 and transmitted to the information processing apparatus 20, as described later. In the following description of the third embodiment, descriptions of elements identical or similar to those in the second embodiment are omitted, and differences from the second embodiment are described.

The first setting control unit 131 requests the first code generation unit 133 to generate a code corresponding to the ID corresponding to the setting registered by the operator 2. The first code generation unit 133 generates a code corresponding to the ID. The first setting control unit 131 transmits the generated code to the second setting control unit 231. As described above, the first setting control unit 131 has a function similar to the function of the transmission unit 111 described in the first embodiment.

The second setting control unit 231 receives the code transmitted from the first setting control unit 131. As described above, the second setting control unit 231 has a function similar to the function of the reception unit 211 described in the first embodiment.

The storage unit of the information processing apparatus 20 stores the information on the setting registered by the operator 2 and the code corresponding to the setting. Multiple sets of setting information and codes may be stored in the storage unit.

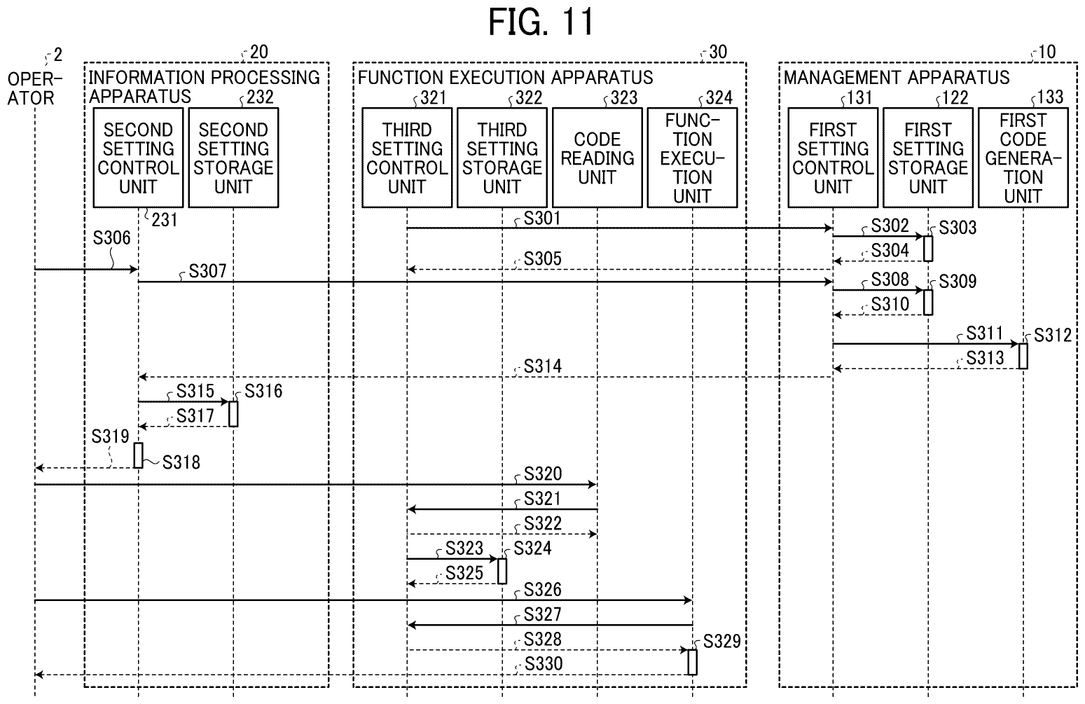

FIG. 11 is a sequence diagram illustrating a process to execute a function according to the third embodiment. The features different from the second embodiment are described below.

In step S311, the first setting control unit 131 requests the first code generation unit 133 to generate a code corresponding to the ID received in step S310. In step S312, the first code generation unit 133 generates a code corresponding to the received ID. In step S313, the first code generation unit 133 returns the generated code to the first setting control unit 131. In step S314, the first setting control unit 131 transmits the received code to the second setting control unit 231. In steps S315 and S316, the second setting control unit 231 requests the second setting storage unit 232 to store the setting information and the ID and code corresponding to the setting information, and the second setting storage unit 232 stores the setting information, the ID, and the code in the storage unit.

As described above, according to the present embodiment, since the management apparatus 10 executes the function to generate a code corresponding to the ID, the amount of processing executed by the information processing apparatus 20 is reduced. In addition, the setting information is transmitted to the function execution apparatus 30 by holding the code displayed by the information processing apparatus 20 over the function execution apparatus 30 that can execute various functions. Accordingly, even when the amount of data in the setting information is large, the setting information registered by the operator 2 is smoothly transmitted to the function execution apparatus 30. Furthermore, the management apparatus 10 and the function execution apparatus 30 store, in the respective storage units, the information on the settings having a finite number of combinations of setting values and the IDs corresponding to the respective settings. Thus, the amount of data to be stored is reduced, compared to, for example, a case where the information on the settings is stored for an unspecified number of operators individually.

### Fourth Embodiment

When a function executed by the function execution apparatus 30 includes multiple versions, a setting item for the function of a certain version may not be supported by the function of another version. For example, the function of version A does not include a setting item for double-sided printing, whereas the function of updated version B includes a setting item newly added for double-sided printing. In a fourth embodiment, even when the version corresponding to the setting registered by the information processing apparatus 20 is different from the version that the function execution apparatus 30 supports, the function can be executed.

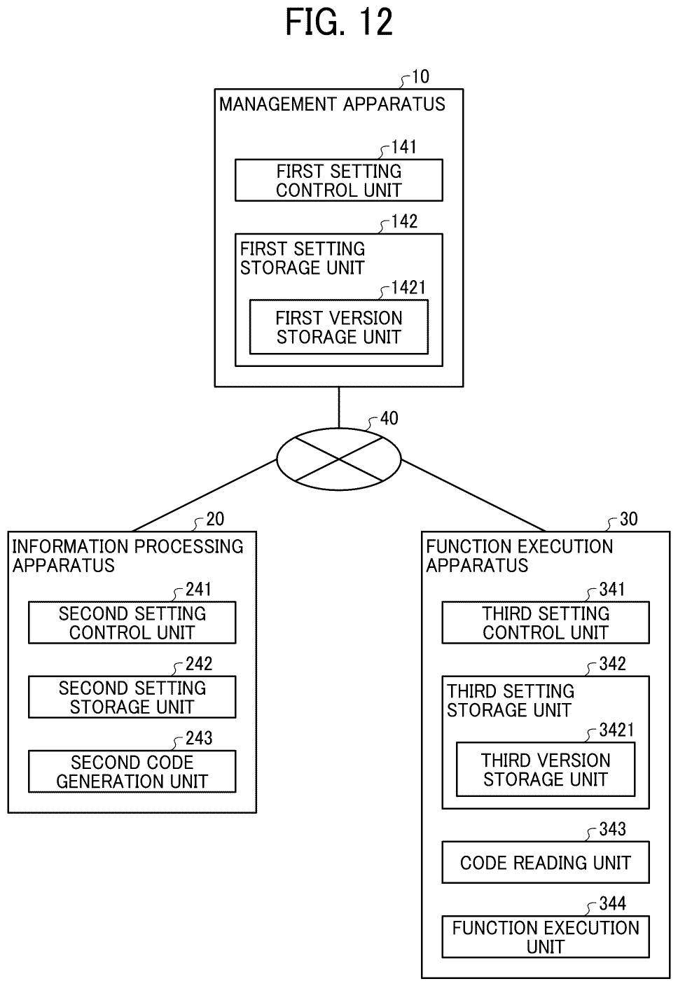

FIG. 12 is a block diagram illustrating a functional configuration of each apparatus included in the information processing system 1 according to the fourth embodiment. The difference from the second embodiment is that the first setting storage unit 142 includes a first version storage unit 1421, and the third setting storage unit 342 include a third version storage unit 3421. In the following description of the fourth embodiment, descriptions of elements identical or similar to those in the second embodiment are omitted, and differences from the second embodiment are described.

In the storage unit of the management apparatus 10, a version list for a function, and the information on all settings for each version and the IDs (values) corresponding to the respective settings as sets are stored. The first setting control unit 141 reads the version list, the information on all settings for each version, and the IDs from the first setting storage unit 142, and transmits the read data to the function execution apparatus 30. The first setting control unit 141 inquires of the first setting storage unit 142 for a value of the latest version corresponding to a specific setting information transmitted from the information processing apparatus 20 and an ID corresponding to the specific setting information, and transmits the value and the ID returned from the first setting storage unit 142 to the information processing apparatus 20.

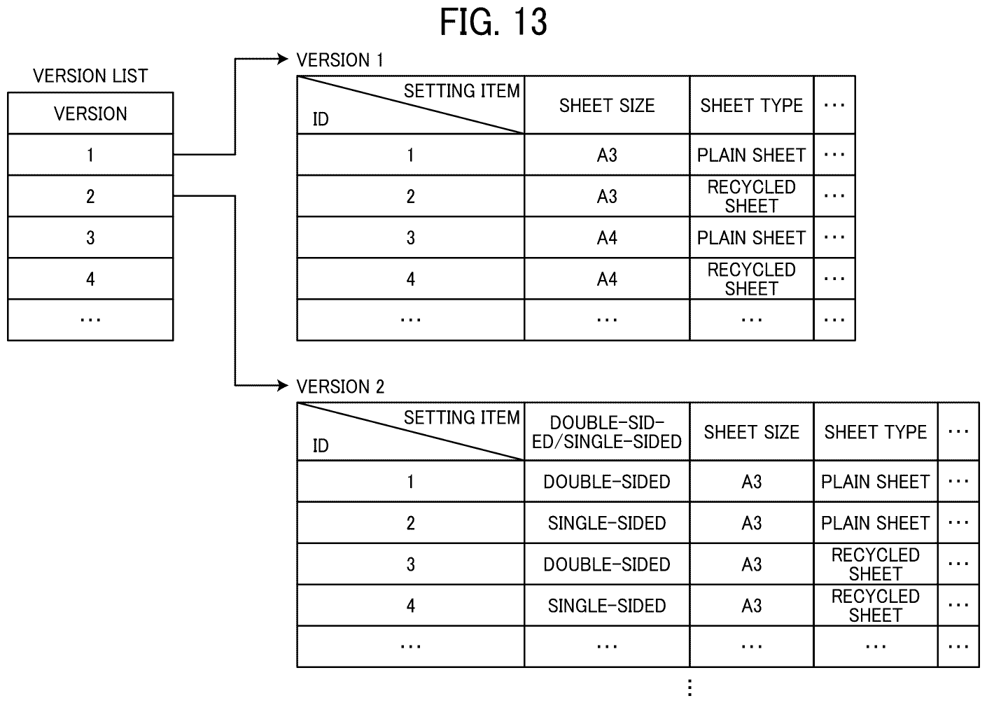

FIG. 13 is a diagram illustrating the version list, and the sets of the information on all settings for each version and the IDs corresponding to the respective settings. On the left section of FIG. 13, a table of the version list is illustrated. The version list contains the values (one, two, three, and so on) of the respective versions. On the right section of FIG. 13, tables of the sets of the information on all settings corresponding to each version and the IDs corresponding to the respective setting are illustrated. In the present embodiment, sets of the information on all settings and the IDs corresponding to the respective settings when the value of the version is one, and sets of the information on all settings and the IDs corresponding to the respective settings when the value of the version is two are presented.

The first setting storage unit 142 reads the version list and the sets of the information on all settings for each version and the IDs corresponding to the respective settings from the storage unit, and returns the read data to the first setting control unit 141. The version list is read out by the first version storage unit 1421 included in the first setting storage unit 142. The first setting storage unit 142 returns the value of the latest version and the ID corresponding to a specific setting information inquired by the first setting control unit 141 to the first setting control unit 141. In the present embodiment, the first setting storage unit 142 is an example of a storage unit that reads or writes setting information and an ID for each version.

The second setting control unit 241 transmits the setting information registered by the operator 2 to the first setting control unit 141, receives the value of the version and the ID corresponding to the setting information from the first setting control unit 141, and requests the second code generation unit 243 to generate a code corresponding to the received value of the version and ID. The second setting control unit 241 instructs the second setting storage unit 242 to store the setting information registered by the operator 2 and the code generated by the second code generation unit 243, and displays the setting information and the code on the display. As described above, the second setting control unit 241 has a function similar to the function of the code display unit 212 described in the first embodiment. The second setting storage unit 242 stores the setting information registered by the operator 2 and the code generated by the second code generation unit 243 in the storage unit.

In the storage unit of the function execution apparatus 30, the version list transmitted from the management apparatus 10, and the sets of the information on all settings for each version and the IDs corresponding to the respective settings are stored. For this purpose, the third setting control unit 341 requests the first setting control unit 141 to transmit the version list, and the sets of the information on all settings for each version and the IDs corresponding to the respective settings, and instructs the third setting storage unit 342 to store the received data. The version list is stored in the storage unit by the third version storage unit 3421 included in the third setting storage unit 342. In the present embodiment, the third setting storage unit 342 is an example of a storage unit that reads or writes setting information and an ID for each version.

The third setting control unit 341 requests the third setting storage unit 342 to transmit setting information corresponding to the value of the version and the ID transmitted from the code reading unit 343, and checks the setting items that the function execution apparatus 30 supports among the setting items included in the received setting information. When the received setting information includes a setting item that the function execution apparatus 30 does not support, the third setting control unit 341 displays the setting item on the display to present the setting item to the operator 2. When the function cannot be executed only with the setting items included in the received setting information, the third setting control unit 341 displays the missing setting item on the display to present the missing setting item to the operator 2. When the operator 2 inputs setting information for an additional setting item through the operation panel 3040, the third setting control unit 341 merges the setting information input by the operator 2 with the setting information received from the third setting storage unit 342. By excluding a setting item that the function execution apparatus 30 does not support and adding a setting item required for the function execution apparatus 30 to execute the function, the third setting control unit 341 merges pieces of the setting information so that there is neither excess nor deficiency in the setting information.

When requested by the function execution unit 344 to transmit the setting information, the third setting control unit 341 returns the setting information corresponding to the value of the version and the ID received from the third setting storage unit 342. The third setting storage unit 342 reads the setting information corresponding to the value of the version and the ID received from the third setting control unit 341 from the storage unit, and returns the setting information to the third setting control unit 341.

The code reading unit 343 transmits the value of the version and the ID corresponding to the read code to the third setting control unit 341.

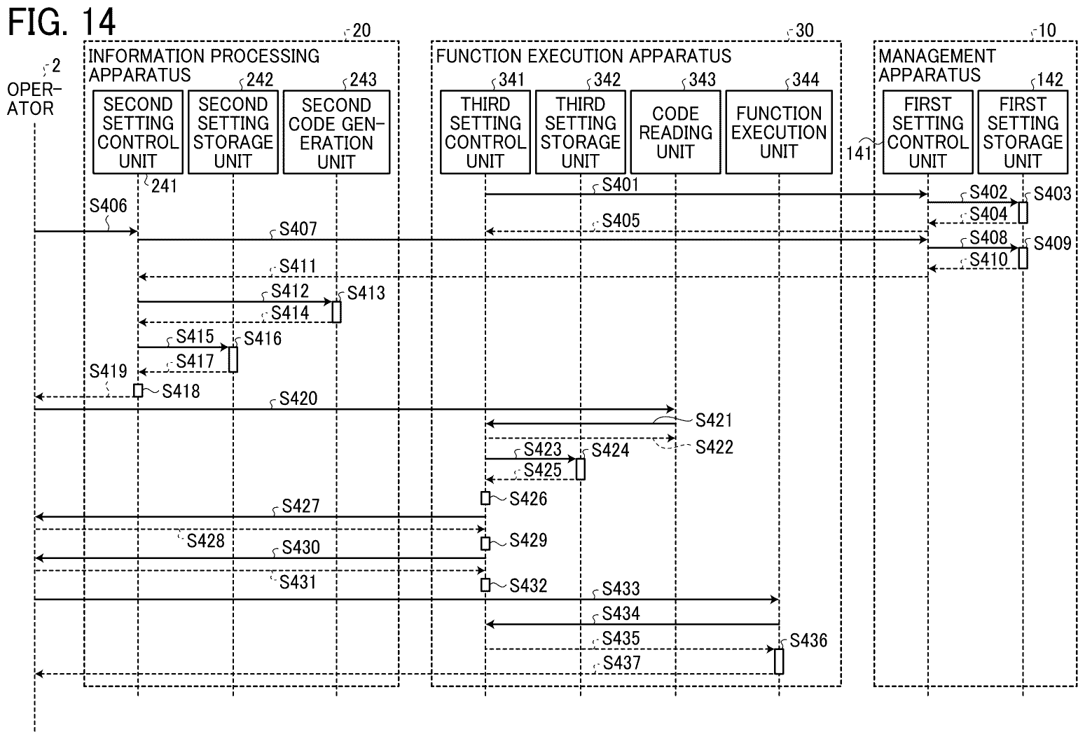

FIG. 14 is a sequence diagram illustrating a process to execute a function according to the fourth embodiment. The features different from the second embodiment are described below.

First, in step S401, the third setting control unit 341 requests the first setting control unit 141 to download a version list, and sets of the information on all settings for each version and the IDs corresponding to the respective settings. In step S402, the first setting control unit 141 requests the first setting storage unit 142 to transmit the version list, and the sets of the information on all settings for each version and the IDs corresponding to the respective settings. In step S403, the first setting storage unit 142 reads the version list, and the sets of the information on all settings for each version and the IDs corresponding to the respective settings from the storage unit. In steps S404 and S405, the first setting control unit 141 transmits the version list, and the sets of the information on all settings for each version and the IDs corresponding to the respective settings received from the first setting storage unit 142 to the third setting control unit 341.

In step S409, the first setting storage unit 142 (and the first version storage unit 1421 included in the first setting storage unit 142) searches for an ID corresponding to the setting information registered by the operator 2 from the setting information of the latest version stored in the storage unit. In step S410, the first setting storage unit 142 transmits the ID searched for in step S409 and the value of the version to the first setting control unit 141. In step S411, the first setting control unit 141 transmits the received ID and value of the version to the second setting control unit 241.

In step S420, the operator 2 holds the code displayed on the display of the information processing apparatus 20 over the code reading unit 343. In steps S421 and S422, the code reading unit 343 transmits the value of the version and the ID corresponding to the read code to the third setting control unit 341.

In step S423, the third setting control unit 341 requests the third setting storage unit 342 (and the third version storage unit 3421 included in the third setting storage unit 342) to transmit the setting information corresponding to the value of the version and the ID. In step S424, the third setting storage unit 342 reads the setting information corresponding to the value of the version and the ID from the data stored in the storage unit. In step S425, the third setting storage unit 342 transmits the read setting information to the third setting control unit 341. In step S426, the third setting control unit 341 checks the difference between the setting information received from the third setting storage unit 342 and the setting information that the function execution apparatus 30 supports.

When the setting information received from the third setting storage unit 342 includes a setting item that the function execution apparatus 30 does not support, in step S427, the third setting control unit 341 displays the setting item that cannot be reflected in the execution of the function on the display to presents the setting item to the operator 2. In step S428, the operator 2 checks the setting item that cannot be reflected, and additionally inputs a setting as needed using the operation panel 3040. In step S429, the third setting control unit 341 merges the setting information received from the third setting storage unit 342 and the setting information additionally input by the operator 2 through the operation panel 3040.

In the case where the setting items received from the third setting storage unit 342 are insufficient for the setting and the function cannot be executed, in step S430, the third setting control unit 341 displays a message indicating that an additional setting is required on the display to present the message to the operator 2. In step S431, the operator 2 checks the message and additionally input a setting using the operation panel 3040 as needed. In step S432, the third setting control unit 341 merges the setting received from the setting storage unit and the setting additionally input by the operator 2.

The sequence when the operator 2 registers one setting is described above. By repeating the operations in steps S406 to S419, the operator 2 is allowed to register multiple settings.

As described above, according to the present embodiment, even when the version corresponding to the setting registered by the information processing apparatus 20 is different from the version supported by the function execution apparatus 30 that can execute various functions, the function can be executed. In other words, even when the setting information registered by the operator 2 is not supported by the function execution apparatus 30 or even when the function cannot be executed due to a lack of a setting item, the function can be executed by presenting the required setting information to the operator 2 and additionally receiving the setting information.

### Fifth Embodiment

A fifth embodiment is described below. In the present embodiment, the function to generate a code described in the fourth embodiment is provided not for the information processing apparatus 20 but for the management apparatus 10.

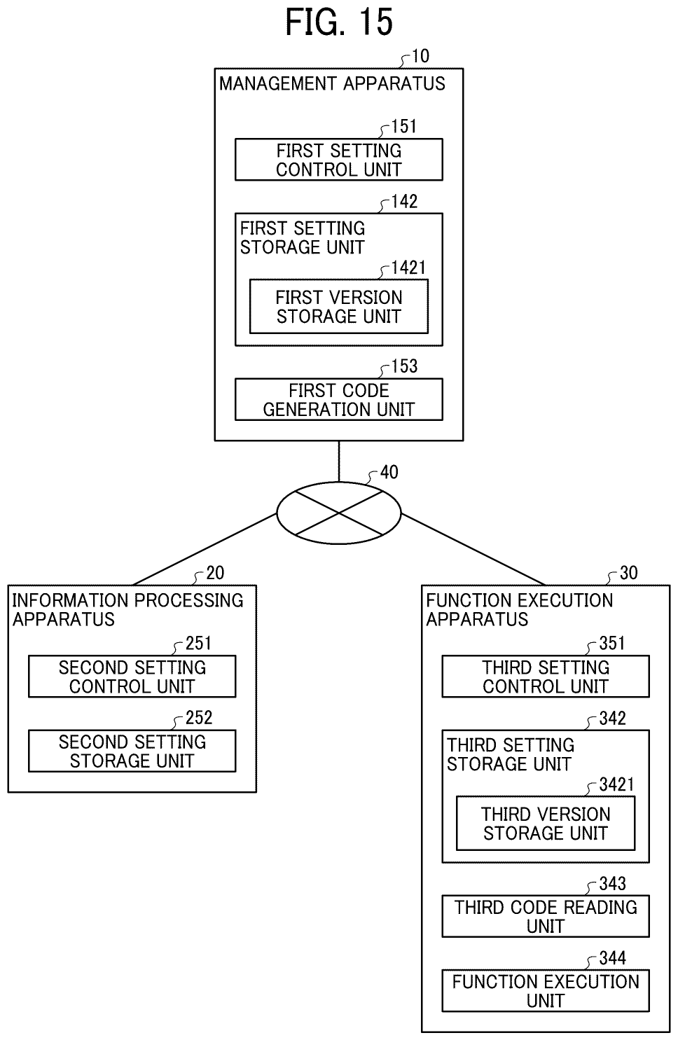

FIG. 15 is a block diagram illustrating a functional configuration of each apparatus included in the information processing system 1 according to the fifth embodiment. The difference from the fourth embodiment is that the management apparatus 10 includes a first code generation unit 153 instead of the information processing apparatus 20 including the second code generation unit 243. Accordingly, as in the third embodiment, a code corresponding to the setting information is generated by the management apparatus 10 and transmitted to the information processing apparatus 20. The code in the present embodiment corresponds to the value of a specific version and the setting information corresponding to the specific version, as in the fourth embodiment. In the following description of the fifth embodiment, descriptions of elements identical or similar to those in the fourth embodiment are omitted, and differences from the fourth embodiment are described.

The first setting control unit 151 requests the first code generation unit 153 to generate a code corresponding to the ID and version of the setting registered by the operator 2, and transmits the generated code to the second setting control unit 251. The first code generation unit 153 generates a code corresponding to the ID and the version.

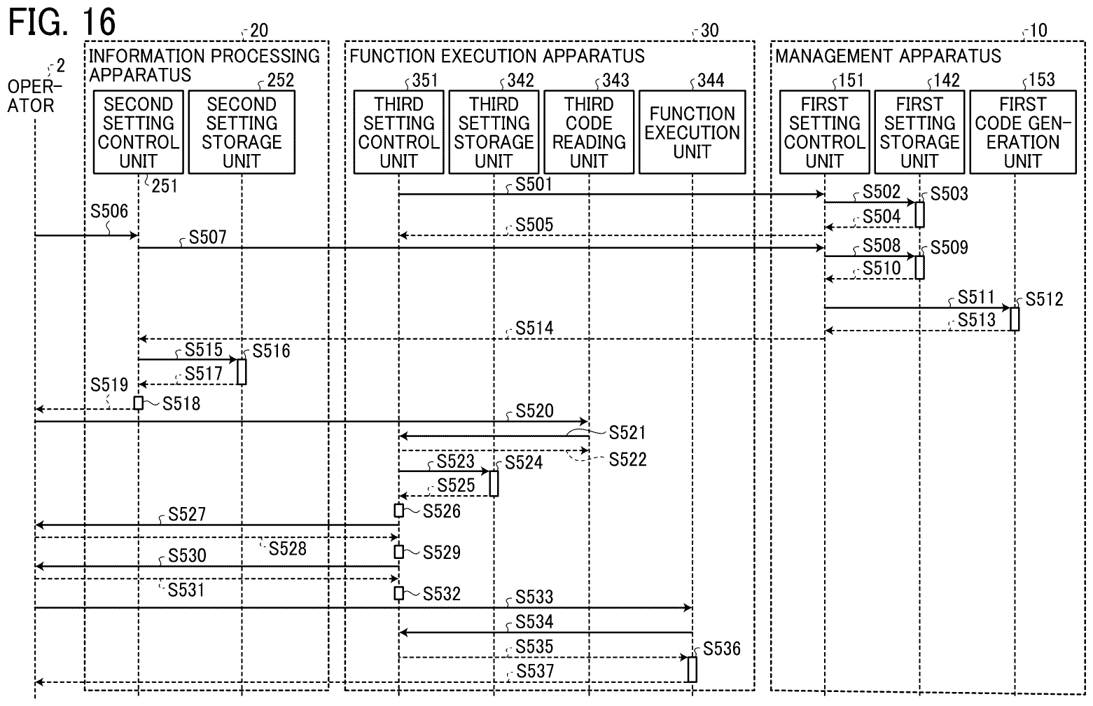

FIG. 16 is a sequence diagram illustrating a process to execute a function according to the fifth embodiment. The features different from the fourth embodiment are described below.

In step S511, the first setting control unit 151 requests the first code generation unit 153 to generate a code corresponding to the ID and version received in step S510. In step S512, the first code generating unit 153 generates a code corresponding to the received ID and version. In step S513, the first code generation unit 153 returns the generated code to the first setting control unit 151. In step S514, the first setting control unit 151 transmits the received code to the second setting control unit 251. In steps S515 and S516, the second setting control unit 251 requests the second setting storage unit 252 to store the setting information and the ID and code corresponding to the setting information, and the second setting storage unit 252 stores the setting information, the ID, and the code in the storage unit.

As described above, according to the present embodiment, since the management apparatus 10 executes the function to generate a code corresponding to the value of the version and the ID in the version, the amount of processing executed by the information processing apparatus 20 is reduced. In addition, the setting information is transmitted to the function execution apparatus 30 by holding the code displayed by the information processing apparatus 20 over the function execution apparatus 30 that can execute various functions. Accordingly, even when the amount of data in the setting information is large, the setting information registered by the operator 2 is smoothly transmitted to the function execution apparatus 30. Furthermore, the management apparatus 10 and the function execution apparatus 30 store, in the respective storage units, the information on the settings having a finite number of combinations of setting values and the IDs corresponding to the respective settings. Thus, the amount of data to be stored is reduced, compared to, for example, a case where the information on the settings is stored for an unspecified number of operators individually.

Although the embodiments of the present disclosure have been described above, the above-described embodiments are presented as examples and are not intended to limit the scope of the present disclosure. Such novel embodiments may be carried out in various other modified forms. Various omissions, substitutions, and changes may be made without departing from the gist of the present disclosure. Such novel embodiments and modifications thereof are within the scope and gist of the present disclosure and are also within the scope of the claims and the equivalent thereof. The elements of different embodiments or modifications may be combined with each other as appropriate.

For example, in the first to fifth embodiments, the function execution apparatus 30 may include a code generation unit and a code display unit, generates a code corresponding to the setting used for the function to be executed, and displays the code on the display. The information processing apparatus 20 may include a code reading unit and reads the code displayed on the display of the function execution apparatus 30. In this case, the information processing apparatus 20 includes a transmission unit that transmits the ID corresponding to the read code to the management apparatus 10, and the management apparatus 10 transmits the setting information corresponding to the received ID to the information processing apparatus 20. By storing the setting information received by the information processing apparatus 20 and the read code in the storage unit of the information processing apparatus 20, the time and effort required for the operator in manually registering the setting information is eliminated. Thus, the convenience is increased for the operator.

Each of the functions of the embodiments described above may be implemented by one or more processing circuits or circuitry. The “processing circuit or circuitry” herein includes a programmed processor to execute each function by software, such as a processor implemented by an electronic circuit, and devices, such as an application-specific integrated circuit (ASIC), a digital signal processor (DSP), a field-programmable gate array (FPGA), and circuit modules known in the art arranged to perform the recited functions.

The group of apparatuses or devices described in the above-described embodiments of the present disclosure are merely one example of a plurality of computing environments that implement embodiments of the present disclosure. In some embodiments, each apparatus or device may include multiple computing devices such as a server cluster. The multiple computing devices communicate with one another through any type of communication link including, for example, a network or a shared memory, and perform the operations disclosed herein.

Aspects of the present disclosure are, for example, as follows.

According to Aspect 1, an information processing system includes an information processing apparatus operated by an operator, a function execution apparatus that executes a function in a setting, and a management apparatus that communicates with the information processing apparatus and the function execution apparatus. The management apparatus includes a code generation unit that generates a code corresponding to the setting, and a transmission unit that transmits the code. The information processing apparatus includes a reception unit that receives the code, and a code display unit that displays the code. The function execution apparatus includes a code reading unit that reads the code displayed by the code display unit, and a function execution unit that executes the function. The function execution unit executes the function based on the setting corresponding to the code read by the code reading unit.

According to Aspect 2, an information processing system includes an information processing apparatus operated by an operator, a function execution apparatus that executes a function in a setting, and a management apparatus that communicates with the information processing apparatus and the function execution apparatus. The management apparatus includes a transmission unit that transmits a value corresponding to the setting. The information processing apparatus includes a reception unit that receives the value corresponding to the setting, a code generation unit that generates a code corresponding to the setting, and a code display unit that displays the code. The function execution apparatus includes a code reading unit that reads the code displayed by the code display unit and a function execution unit that executes the function. The function execution unit executes the function based on the setting corresponding to the code read by the code reading unit.

According to Aspect 3, in the information processing system of Aspect 2, the management apparatus further includes a storage unit that stores information on all settings used for executing the function and codes corresponding to the respective settings, the information processing apparatus further includes a storage unit that stores the value corresponding to the setting received by the reception unit and a setting corresponding to the code, and the function execution apparatus further includes a storage unit that stores the information on all settings and the codes corresponding to the respective settings.

According to Aspect 4, in the information processing system of Aspect 1, the management apparatus further includes a storage unit that stores information on all settings used for executing the function and codes corresponding to the respective settings, the information processing apparatus further includes a storage unit that stores the code received by the reception unit and the setting corresponding to the code, and the function execution apparatus further includes a storage unit that stores the information on all settings and the codes corresponding to the respective settings.

According to Aspect 5, in the information processing system of any one of Aspects 1 to 4, the function includes multiple versions, the management apparatus further includes a storage unit that stores all settings used for each of the multiple versions and codes corresponding to the respective settings for each version, the code generation unit generates a code corresponding to one of the versions and one of the settings, the function execution apparatus further includes a storage unit that stores all the settings used for each of the multiple versions and the codes corresponding to the respective settings for each version, and the function execution apparatus executes the function based on the one of the versions and the one of the settings corresponding to the code.

According to Aspect 6, in the information processing system of any one of Aspects 1 to 5, the function execution apparatus further includes a code generation unit that generates a code corresponding to the setting, and a code display unit that display the code, the information processing apparatus further includes a code reading unit that reads the code displayed by the code display unit of the function execution apparatus, a transmission unit that transmits a value corresponding to the code read by the code reading unit, and a storage unit that stores the setting and the code corresponding to the setting, and the management apparatus further includes a reception unit that receives the value transmitted by the transmitting unit of the information processing apparatus. The management apparatus transmits information on a setting corresponding to the value. The information processing apparatus stores the setting transmitted by the management apparatus and the code read by the code reading unit of the information processing apparatus.

According to Aspect 7, in the information processing system of any one of Aspects 1 to 6, a value different from each other is assigned to the code for each of all the settings used for executing the function.

According to Aspect 8, in the information processing system of any one of Aspects 1 to 7, the code includes a two-dimensional code.

According to Aspect 9, in the information processing system of any one of Aspects 1 to 8, the function execution apparatus is an image forming apparatus.

According to Aspect 10, an information processing method is used by an information processing apparatus operated by an operator, a function execution apparatus that executes a function in a setting, and a management apparatus that communicates with the information processing apparatus and the function execution apparatus. The method includes generating a code corresponding to the setting with the management apparatus, transmitting the code with the management apparatus, receiving the code with the information processing apparatus, display the code with the information processing apparatus, reading the displayed code with the function execution apparatus, and executing the function with the function execution apparatus. The method further includes executing, with the function execution apparatus, the function based on a setting corresponding to the code read with the function execution apparatus.

According to Aspect 11, a non-transitory recording medium stores a plurality of program codes which, when executed by one or more processors, causes the one or more processors to perform a method used by an information processing apparatus operated by an operator, a function execution apparatus that executes a function in a setting, and a management apparatus that communicates with the information processing apparatus and the function execution apparatus. The method includes generating a code corresponding to the setting with the management apparatus, transmitting the code with the management apparatus, receiving the code with the information processing apparatus, display the code with the information processing apparatus, reading the displayed code with the function execution apparatus, and executing the function with the function execution apparatus. The method further includes executing, with the function execution apparatus, the function based on a setting corresponding to the code read with the function execution apparatus.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing system comprising:
an information processing apparatus operated by an operator;
a function execution apparatus to execute a function; and
a management apparatus to communicate with the information processing apparatus and the function execution apparatus,
the management apparatus including first circuitry configured to:
generate a code corresponding to a setting to be used in executing the function; and
transmit the code,
the information processing apparatus including second circuitry configured to:
receive the code; and
display, on a display, the code, and
the function execution apparatus including third circuitry configured to:
read the code displayed on the display; and
execute the function based on the setting corresponding to the code read by the third circuitry.

2. An information processing system comprising:
an information processing apparatus operated by an operator;
a function execution apparatus to execute a function; and
a management apparatus to communicate with the information processing apparatus and the function execution apparatus,
the management apparatus including first circuitry configured to transmit a value corresponding to a setting to be used in executing the function,
the information processing apparatus including second circuitry configured to:
receive the value;
generate a code corresponding to the setting using the value; and
display, on a display, the code, and
the function execution apparatus including third circuitry configured to:
read the code displayed on the display; and
execute the function based on the setting corresponding to the code read by the third circuitry.

3. The information processing system according to claim 2, wherein:
the management apparatus further includes a memory that stores information on all settings available for use in executing the function and codes corresponding to the respective settings; and
the function execution apparatus further includes another memory that stores the information on all the settings and the codes corresponding to the respective settings.

4. The information processing system according to claim 1, wherein:
the management apparatus further includes a first memory that stores information on all settings available for use in executing the function and codes corresponding to the respective settings;
the information processing apparatus further includes a second memory that stores the code and a setting corresponding to the code; and
the function execution apparatus further includes a third memory that stores the information on all the settings and the codes corresponding to the respective settings.

5. The information processing system according to claim 1, wherein:
the function includes a plurality of functions having a plurality of versions;
the management apparatus further includes a memory that stores all settings available for each of the plurality of versions and codes corresponding to the respective settings for each version;
the function execution apparatus further includes another memory that stores all the settings available for each of the plurality of versions and the codes corresponding to the respective settings for each version;
the first circuitry is configured to generate a code corresponding to one of the plurality of versions and one of the settings; and
the function execution apparatus executes the function based on the one of the plurality of versions and the one of the settings corresponding to the code.

6. The information processing system according to claim 1, wherein,
the third circuitry is configured to:
generate another code corresponding to the setting to be used in executing the function; and
display, on another display, the code,
the second circuitry is configured to:
read the other code displayed on the display displayed by the third circuitry of the function execution apparatus; and
transmit a value corresponding to the other code read by the second circuitry,
the first circuitry is configured to:
receive the value transmitted by the second circuitry of the information processing apparatus; and
transmit information on the setting corresponding to the value, and
the information processing apparatus further includes a memory that stores the setting of the code generated and transmitted by the management apparatus, the code generated and transmitted by the management apparatus, and the other code generated by the third circuitry and read by the second circuitry of the information processing apparatus.

7. The information processing system according to claim 1, wherein the setting includes a plurality of settings used in executing the function, and the code includes a plurality of different values for the plurality of settings.

8. The information processing system according to claim 1, wherein the code includes a two-dimensional code.

9. The information processing system according to claim 1, wherein the function execution apparatus is an image forming apparatus.

10. An information processing method performed by an information processing system including an information processing apparatus operated by an operator, a function execution apparatus, and a management apparatus, the method comprising:
with the management apparatus, generating a code corresponding to a setting to be used in executing a function of the function execution apparatus;
transmitting the code from the management apparatus to the information processing apparatus;
displaying the code on a display for the information processing apparatus;
reading the displayed code with the function execution apparatus; and
executing, with the function execution apparatus, the function based on the setting corresponding to the code that is read.

11. A non-transitory recording medium storing a plurality of program codes which, when executed by one or more processors on an information processing system including an information processing apparatus operated by an operator, a function execution apparatus, and a management apparatus, causes the one or more processors to perform an information processing method, the method comprising:
with the management apparatus, generating a code corresponding to a setting to be used in executing a function of the function execution apparatus;
transmitting the code from the management apparatus to the information processing apparatus;
displaying the code on a display for the information processing apparatus;
reading the displayed code with the function execution apparatus; and
executing, with the function execution apparatus, the function based on the setting corresponding to the code that is read.
